(19) United States
(12) Patent Application Publication
(10) Pub. No.: US 2005/0041355 A1
(43) Pub. Date: Feb. 24, 2005

(54) Monitoring and response system

(76) Inventor: J. Dennis Page, Rincon, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 10/672,589

(22) Filed: Sep. 26, 2003

Related U.S. Application Data
(63) Continuation-in-part of application No. 09/868,290, filed on Jun. 15, 2001, now Pat. No. 6,674,625.
(60) Provisional application No. 60/114,832, filed on Jan. 6, 1999.

(51) Int. Cl. H02H 1/00

(52) U.S. Cl. 361/117; 340/601

(57) ABSTRACT

A monitoring and response system including a monitoring device for detecting one or more conditions, a transmission system for sending control codes, and multiple devices for actively performing functions in response to the control codes. The monitoring device may consist of multiple detectors located in different geographic areas. The monitoring device may also be an external system. In the external monitoring device configuration, a centralized monitoring device detects and locates the conditions and transmits this information to the transmission system. The transmission system then transmits control commands to the devices.

This application is a continuation-in-part of co-pending U.S. application Ser. No. 09/868,290 entitled “Lightning Protection Systems” filed Jun. 15, 2001, which is the national phase of International Application No. PCT/US00/00168 filed Jan. 5, 2000, which claims the benefit of U.S. Provisional Application No. 60/114,832 filed Jan. 6, 1999, all of which are herein incorporated in the entirety by this reference.

### RELATED FIELDS

This invention relates to systems and devices for monitoring and automatically responding to detected conditions such as environmental conditions.

### BACKGROUND

Environmental conditions can change suddenly, often with dramatic and potentially dangerous and/or harmful results. Lightning strikes can result in data loss and damage to electronic equipment. Excessive wind can damage windows. Large snowfalls can result in avalanches and roof collapses. Smog and other types of pollution can cause breathing problems. Clearly, environmental changes, when unanticipated or unprepared for, have the potential to cause damage throughout geographic areas affected by the changes.

Various devices have been developed in an attempt to lessen or prevent harm resulting from such environmental changes. For example, U.S. Pat. No. 5,453,899 (the “899 patent”) entitled “Lightning Protection Device,” which is incorporated herein by this reference, discloses a lightning protection device that physically interrupts the electrical connection between electrical and electronic equipment and the power grid when lightning is detected in the vicinity of the equipment by a radio frequency receiver tuned to a frequency that generates a voltage in response to radio frequency static in the general vicinity. U.S. Pat. No. 5,291,208 entitled “Incipient Lightning Detection and Device Protection,” which is incorporated herein by this reference, discloses several other detecting mechanisms for sensing electrical activity in the general vicinity of the device.

An important concern with these prior lightning protection devices is that control of the device is typically limited to detection of dangerous atmospheric conditions such as disclosed in the above-referenced patents. Detection of dangerous atmospheric conditions at the precise location of the protection device may not be sufficient to protect the device from damage. For example, some electronic equipment may be located within structures where relevant radio frequencies are difficult to receive. In addition, because electrical storms tend to cover a large geographic area and tend to move quickly, they are very difficult to detect based on one geographical data point. Therefore, sensors located on protection devices may not have the range, sensitivity, or accuracy to detect distant atmospheric conditions that may still damage the equipment being protected. Even if more sensitive sensors were employed, the cost of such an approach could be cost prohibitive.

Although lightning protection devices may permit users to manually disconnect equipment from external conductors, this is no different than merely unplugging the equipment. Additionally, commercial users of such devices may be inconvenienced by having to have multiples of such units distributed throughout the building to protect a variety of electronic devices. Likewise, a homeowner may be similarly inconvenienced by having to move about an entire house to trigger multiple devices attached to various outlets.

U.S. Pat. No. 6,404,880, entitled “Method and Apparatus for Delivering Critical Information” and issued Jun. 11, 2002 to Stevens, discloses a method and apparatus for alerting subscribers to severe weather. Stevens discloses using a cellular network to deliver a message to a subscriber's cellular phone warning of severe weather or traffic jams when these conditions are detected. Such a system however may be undesirable because subscribers still must take affirmative action to protect themselves and/or their property from the imminent severe weather. For example, if a subscriber received a cellular message that a thunder storm was approaching her area, the subscriber would still have to unplug all of her electronic devices to protect them from potential lightning strikes.

### SUMMARY

Various embodiments of the present invention include monitoring and response systems for automatically taking actions in response to the detection of certain conditions, such as, but not limited to, the detection of lightning strikes, high winds, snow accumulation or other environmental conditions. The system may include a monitoring device, a regional transmission system, and a number of automatic response devices. The monitoring device may be adapted to monitor at least one condition, which may be an environmental condition or a precursor condition to an environmental condition. The monitoring device may also be adapted to cause the regional transmitter to transmit or cease transmitting a control signal into or throughout a geographic area. The automatic response devices may be located in the geographic area and adapted to receive the control signals and respond to the presence or absence of the control signals by performing a function.

For example, the monitoring and response system may be a lightning protection system adapted to protect electrical and electronic equipment by monitoring dangerous atmospheric conditions in a particular geographic area and transmitting control signals to electrical circuit connection/disconnection devices in the geographic area, which have a receiver for receiving the transmitted control signals and an interruption mechanism for automatically disconnecting and reconnecting the electrical equipment from external conductors in response to the presence or absence of the control commands.

The monitoring device may consist of multiple detectors located in different geographic areas. In the external monitoring device configuration, a centralized monitoring device detects and locates conditions, such as dangerous atmospheric conditions, and transmits this information to the transmission system. The transmission system then transmits control commands to the automatic response devices, such as the electrical circuit connection/disconnection devices.

The automatic response devices may be adapted to include “manual override” functionality. For example, to further enhance the protection of electrical equipment, an electrical circuit connection/disconnection device may also be controlled in a number of other ways than by the control signals. For example, the electrical circuit connection/disconnection device may be manually operated with the use of a “stomp” switch, which manually forces the disconnect process. Alternatively, a remote control may be used permitting the user to remotely activate the electrical circuit connection/disconnection device via a hand-held remote control unit, computer, modem, the Internet, telephone, wireless telephone, or any alternative means of remote communication. In a similar manner, multiple electrical circuit connection/disconnection devices may be connected together in a local area or large area network and controlled in a similar, remote manner. Manual triggering of the electrical circuit connection/disconnection devices may be desirable where certain structures interfere with lightning detection, thus rendering automated disconnection impractical; when normal sources of electrical power have failed; where dangerous, non-lightning related voltages may occur; when a user desires to have the protected equipment powered down; and when peace of mind or convenience dictates disconnection of the protected equipment.

Accordingly, it is a feature of certain embodiments of this invention to provide a monitoring device with an accurate, sensitive, and precise detector capable of detecting and locating certain conditions.

Another feature of certain embodiments of this invention is to provide an intelligent monitoring and response system that may detect and locate certain conditions in a specific geographic area and cause devices within the area to automatically respond to the detected conditions.

Another feature of certain embodiments of this invention is to provide an improved electrical circuit connection/disconnection device for protecting electrical and electronic equipment from various electrical surges that may be controlled by geographically specific radio broadcasts.

Another feature of certain embodiments of this invention is to provide an improved electrical circuit connection/disconnection device for protecting electrical and electronic equipment from various electrical surges, which has a disconnect mechanism with sufficient insulative capacity to prevent even extreme voltage surges from crossing the insulative barrier.

Another feature of certain embodiments of the present invention is to provide automatic response devices for use in a monitoring and response system that may also be controlled manually.

Yet another feature of certain embodiments of the present invention is to provide automatic response devices, which may be controlled remotely and in network fashion.

### BRIEF DESCRIPTION

FIG. 1 is a schematic diagram of a first embodiment of a monitoring and response system of this invention.

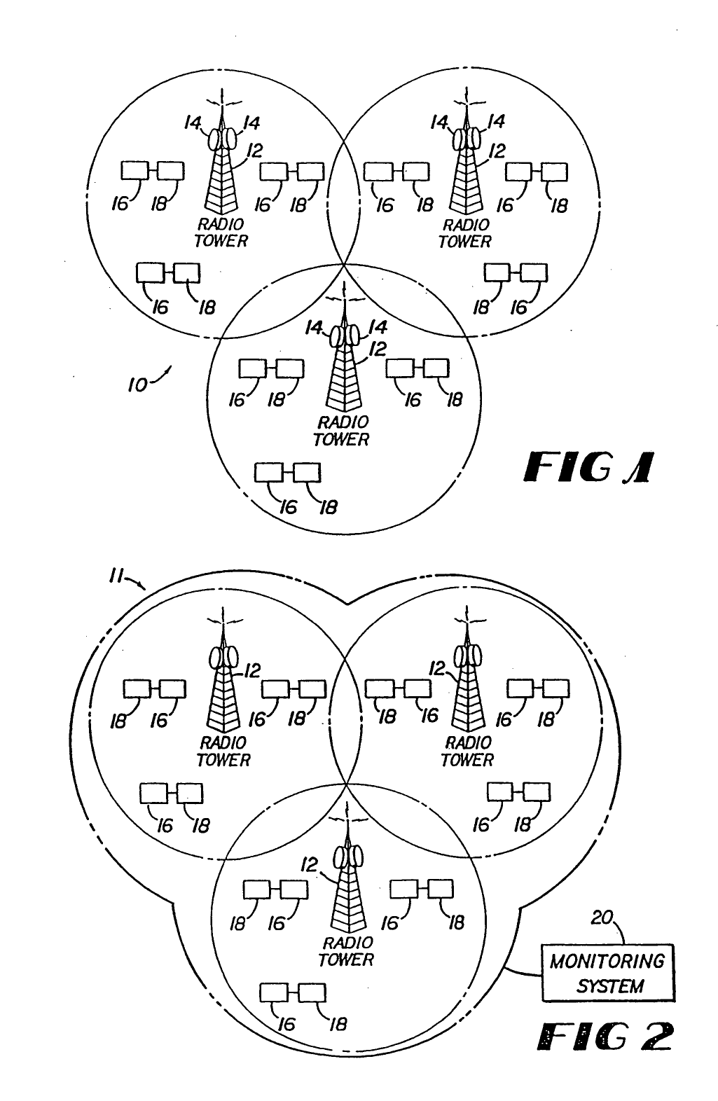

FIG. 2 is a schematic diagram of another embodiment of a monitoring and response system of this invention.

FIG. 3 is a schematic diagram of another embodiment of a monitoring and response system of this invention.

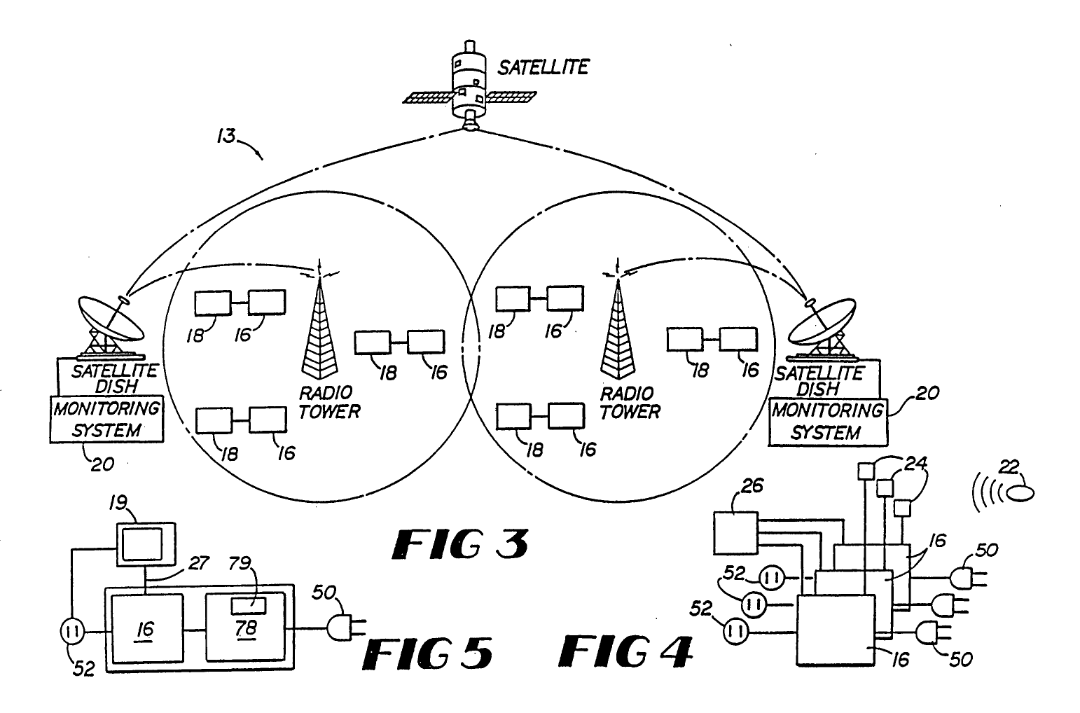

FIG. 4 is a schematic diagram of another embodiment of a monitoring and response system of this invention.

FIG. 5 is a schematic diagram of one automatic response device usable in systems shown in FIGS. 1-4.

FIG. 6 is an exploded perspective view of an embodiment of another automatic response device usable in the systems shown in FIGS. 1-4.

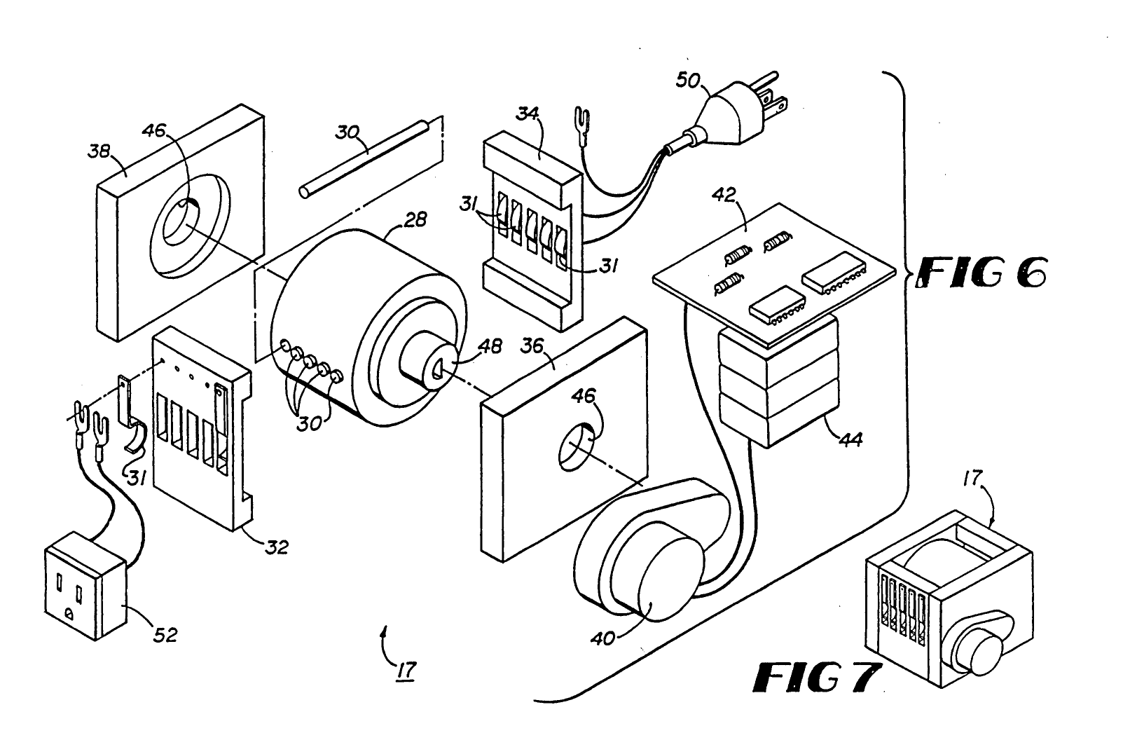

FIG. 7 is a perspective view of the device shown in FIG. 6.

FIG. 8 is a schematic side elevation view a portion of a device similar to that shown in FIGS. 6 and 7 positioned in a connected state.

FIG. 9 depicts the device shown in FIG. 8 positioned in a disconnected state.

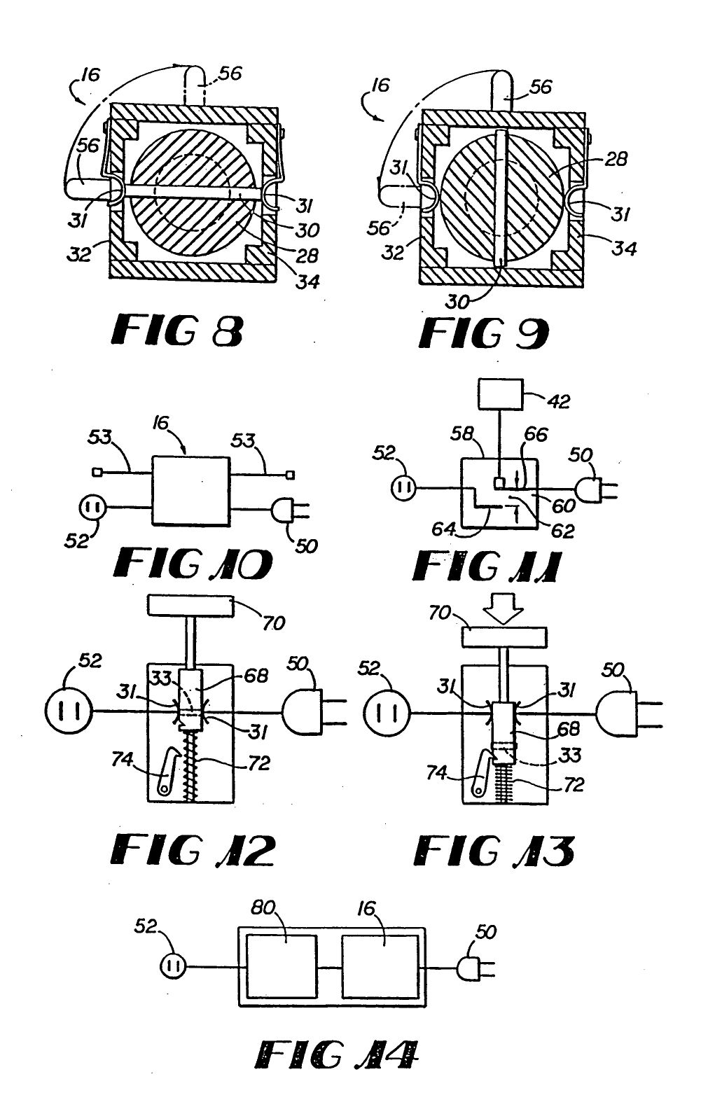

FIG. 10 is a schematic diagram of the external connectivity of a electrical circuit connection/disconnection device usable in the systems of FIGS. 1-4.

FIG. 11 is a schematic diagram of another electrical circuit connection/disconnection device usable in the systems illustrated in FIGS. 1-4.

FIG. 12 is a schematic diagram of another electrical circuit connection/disconnection device usable in systems illustrated in FIGS. 1-4, the device positioned in a connected state.

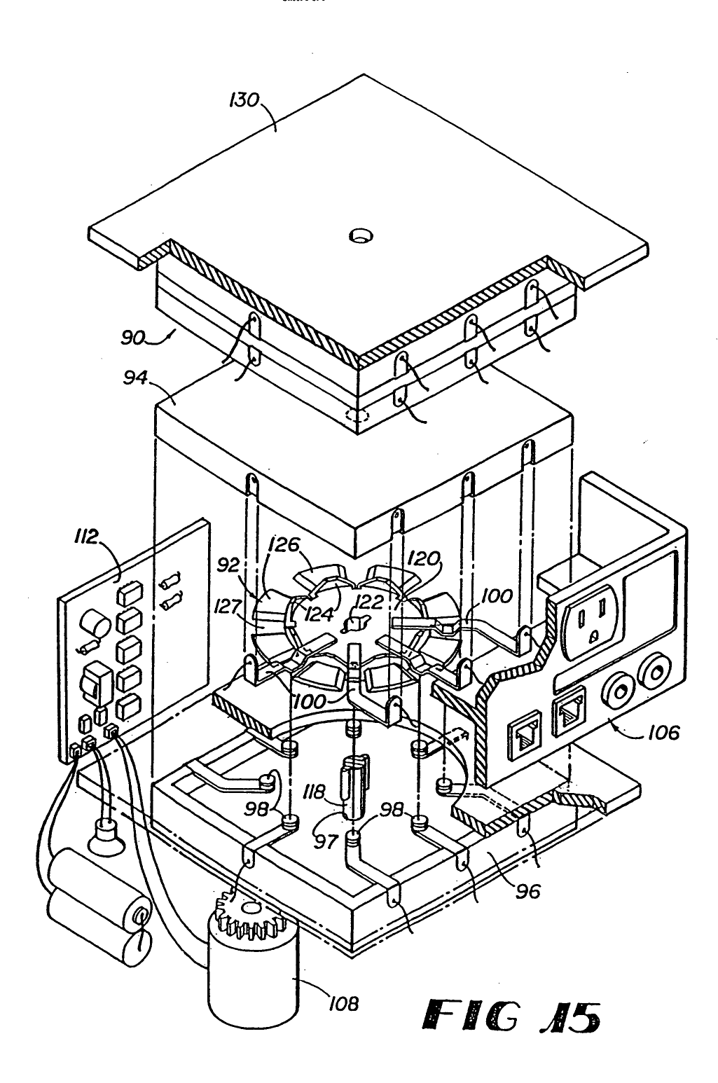

FIG. 13 is a schematic diagram of the electrical circuit connection/disconnection device of FIG. 12 positioned in a disconnected state.

FIG. 14. is a schematic diagram of another electrical circuit connection/disconnection device usable in the systems illustrated in FIGS. 1-4.

FIG. 15 is an exploded perspective view of another electrical circuit connection/disconnection device usable in the systems illustrated in FIGS. 1-4.

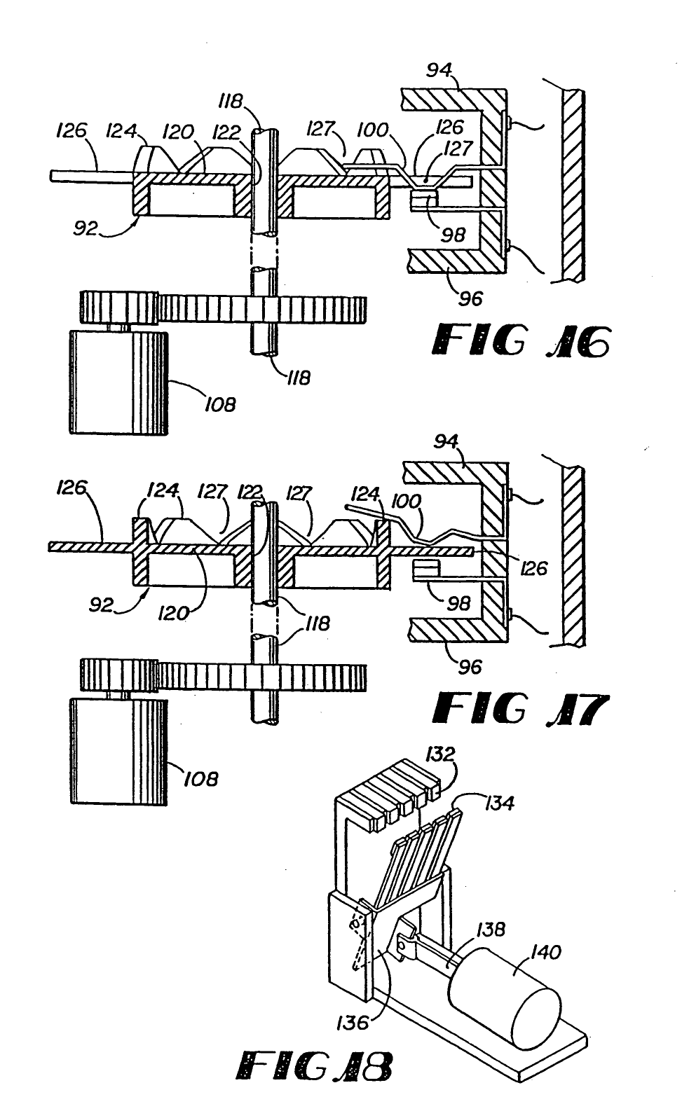

FIG. 16 is a schematic side elevation view of a portion of the device shown in FIG. 15, the device shown in a connected state.

FIG. 17 is a schematic side elevation view of the portion of the device shown in FIG. 16 shown in a disconnected state.

FIG. 18 is a perspective view of another electrical circuit connection/disconnection device usable in the systems illustrated in FIGS. 1-4.

### DETAILED DESCRIPTION

FIGS. 1-3 show monitoring and response systems 10, 11 and 13 respectively according to certain embodiments of the present invention. As shown in FIG. 1, monitoring and response system 10 includes a plurality of monitoring devices 14 adapted to detect or monitor at least one condition, a plurality of regional transmitters 12 communicatively associated with the monitoring devices 14, and a plurality of automatic response devices 16 adapted to receive signals from the regional transmitters 12 and to perform certain functions. In other embodiments, such as the embodiments shown in FIGS. 2 and 3, a single monitoring device 20 replaces the plurality of monitoring devices 14 shown in FIG. 1. In still other embodiments, monitoring and response systems 10, 11 and/or 13 may include both types of monitoring devices 14 and 20.

Monitoring devices 14 and/or 20 may monitor any desired and/or appropriate condition, conditions, precursor condition or precursor conditions. For instance, monitoring devices 14 and/or 20 may monitor: lightning strikes, static electricity, potential or actual differences in electricity, rain clouds, storm clouds, other clouds, wind velocity, wind direction, barometric pressure, humidity, temperature, ground temperature, air temperature, water temperature, relative temperature, rain, snow, hail, sleet, ice, ozone, pollen, radiation, air quality, seismic activity, ocean levels, ocean currents, vehicular traffic, meteor showers, other space related occurrences, nuclear agents, biological agents, chemical agents, sulfur compounds, carbon compounds, natural gas emissions, oil or gas spills, pedestrian density, traffic density, migratory patterns, plant life density or simply monitor other monitoring devices, including Internet based weather monitoring services, that monitor these or other conditions. Monitoring devices 14 and/or 20 may also monitor the absence of any of the aforementioned conditions. Monitoring devices 14 and/or 20 may be any appropriate monitoring device capable of monitoring the desired condition. For instance, monitoring devices 14 and/or 20 may be a device sensitive to electrical disturbances useful for monitoring potential lightning strikes. In other embodiments, monitoring devices 14 and/or 20 may use any desired mechanism to detect a desired condition or conditions. For instance, monitoring devices 14 and/or 20 may be satellites, cameras, barometers, thermometers, rain gauges, wind speed gauges or any other desired monitoring device.

Monitoring devices 14 and/or 20 may monitor these or other conditions in any desired geographic area. In some embodiments, such as the embodiment shown in FIG. 1, the geographic area monitored by monitoring devices 14 is approximately equal to the geographic area covered by the effective range of the regional transmitters 12. In other embodiments, such as the embodiment shown in FIG. 2, monitoring device 20 monitors a desired condition within or outside the geographic area covered by the effective range of the regional transmitters 12. Monitoring conditions outside the effective range of the regional transmitters 12 may be useful for predicting conditions that may arise in the future inside the effective range of the regional transmitters 12. For instance, monitoring device 20 may monitor a thunderstorm that is outside of the effective range of the regional transmitters, yet may in the future come within the geographic area defined by the effective range of the regional transmitters.

Monitoring and response systems 10, 11 and/or 13 may be useful in a variety of situations. For instance, monitoring and response systems 10, 11 or 13 may monitor wind speeds and signal devices 16 to roll up storm shutters when the wind speeds exceed a defined limit. Alternatively, systems 10, 11 or 13 may monitor rain fall such that devices 16 are signaled to interrupt irrigation cycles when a defined amount of rain is predicted or occurs. In other embodiments, systems 10, 11 or 13 may monitor snowfall or predicted snowfall and activate avalanche-warning signs when dangerous snow accumulation is detected or predicted. In still other embodiments, systems 10, 11 and 13 may monitor pollution levels and signal devices 16 to introduce supplemental oxygen into the air handling systems of nursing homes when pollution levels exceed a defined limit. As one final example, which is described in more detail below, monitoring and response systems 10, 11 or 13 may monitor the potential for lightning strikes in a certain geographic area and signal disconnect devices 16 to disconnect electronic equipment 18 when there is a danger of lightning strikes in the area.

Lightning Protection Systems

In the embodiment illustrated in FIG. 1, monitoring and response system 10 is a lightning protection system 10. As shown in FIG. 1, system 10 comprises a plurality of lightning detectors 14, which are associated with the regional transmitters 12. In the embodiment shown in FIG. 1, devices 16 comprise a plurality of electrical circuit connection/disconnection devices 16 for protecting electrical and electronic equipment 18. Devices 16 may be adapted to respond to signals, or lack of signals, from regional transmitters 12 to connect or disconnect equipment 18 from electrical conductors, such as, but not limited to, power sources, datalines, coaxial cable, telephone lines, low-voltage control lines, and any other digital or analog electrical source or signal used as an external conductor in electrical or electronic equipment. System 10 may protect electrical and electronic equipment 18 by detecting and locating dangerous atmospheric conditions in a particular geographic area using lightning detectors 14 and transmitting broadcast control commands throughout the affected geographic area to devices 16, which disconnect electrical and electronic equipment 18 from all or a portion of external conductors in response to the control commands from regional broadcast transmitters 12. System 10 may send audible warnings to devices 16 prior to transmission of control signals, which may enable users of devices 16 to override disconnection of devices 16 from electrical and electronic equipment 18. System 10 may also use the control signals to reconnect electrical and electronic equipment 18 to the disconnected external conductors. Since relatively few regional broadcast sites 12 and lightning detectors 14 are needed, it is economically feasible to design each lightning detector 14 to have substantial range, sensitivity, and accuracy for detecting and locating atmospheric conditions. Because electrical circuit connection/disconnection devices 16 need not incorporate their own lightning detectors, each device 16 may be small and inexpensive. Additionally, because central lighting detectors may be of a higher quality than may be affordable for a single user, more accurate control of devices 16 can be achieved.

Devices 16 in system 10 may be assigned a control address based on the location of the device within the geographical area of the lightning protection system. For example, the entire geographical area of system 10 may be divided up into distinct regions with each device 16 in a particular region being assigned the same control address. Although in FIG. 1 each distinct region corresponds to the transmission radius of regional broadcast sites 12, the size and shape of each distinct region and corresponding control address in the lightning protection system may be independent of the size and shape of the transmission radius of sites 12. In this manner, devices 16 within each distinct region may be controlled by transmission systems using any cellular, pager or any other suitable communications technology, including future systems not presently available that may transmit common control signals to devices having specific control addresses.

Lightning detectors 14 may be provided on each site 12 to detect lightning activity in the vicinity of the region. Each site 12 broadcasts control signals using a common numerical code, such as, for example, a pager “capcode” or any alternative control command system that may activate only devices 16 within that particular region. Because regional lightning detectors 14 cover relatively small geographic areas, accurate control over devices 16 is possible. System 10 may also enable devices 16 to receive encoded broadcasts, such as, for example, the National Weather Service's Specific Area Message Encoded (SAME) broadcasts or any alternative encoded broadcast, in addition to those controlling the devices 16 to provide redundancy or to provide the user with specific weather information, including weather alarms. Moreover, each of sites 12 and detectors 14 may be linked together to form a network. In this manner, detection data from each of the detectors 14 may be compared to accurately track storm movement and activate devices 16 only in specific danger areas.

As an alternative to the multiple lightning detectors 14 shown in FIG. 1, a centrally located detector within each distinct geographic region could control transmission from sites 12.

FIGS. 2 and 3 illustrate alternative embodiments of lightning protection systems of this invention where the dangerous atmospheric conditions may be detected and located by a monitoring device 20 located outside the coverage area of sites 12. Monitoring device 20 may be a centralized weather monitoring device, such as, for example, the National Weather Service, the National Hurricane Service, the National Lightning Detection Network, which is owned and operated by Global Atmospherics, Inc., or any alternative centralized weather monitoring and location system. As shown in FIG. 2, in system 11, sites 12 may receive relevant atmospheric data from monitoring device 20, and sites 12 then retransmit broadcast control signals to devices 16 as described above.

As shown in FIG. 3, in system 13, a monitoring device 20 may communicate broadcast control signals to devices 16 via a terrestrial paging network with satellite interconnectivity or via any alternative paging or radio configuration.

It should be understood that lightning protection systems according to certain embodiments of this invention may be practiced using as connection/disconnection device 16 any appropriate apparatus for electrically disconnecting electric circuits from electrical and electronic equipment 18 and achieving sufficient insulation or physical separation to reduce the likelihood that a power surge by lightning or other electrical disturbance will travel from disconnected external conductors to electrical and electronic equipment 18.

Service Provider/Subscriber System

Monitoring and response systems 10 or 11 may be implemented according to certain embodiments of the present invention using a service provider/subscriber business scheme. For example, existing service providers, such as, for example, cellular service providers, personal communications service providers, paging service providers, or any alternative wireless or dataline service providers, may include automatic response services as described above separately or in their bundle of services. Because existing telecommunications service providers already have the necessary infrastructure, equipment, and subscribers, various systems of this invention may be implemented with very little cost to service providers. Costs for servicing a large number of subscribers may be limited to a single monitoring device 14 or 20, an autodialing device, and nominal monthly telephone and pager service fees. Service providers may offer monitoring and response services to individuals and businesses based on a nominal monthly rate. Service providers may initially sell devices 16 to subscribers or they may give devices 16 away to new subscribers. This service provider/subscriber scheme enables service providers to leverage their existing infrastructure and subscriber base to provide inexpensive and valuable monitoring and response services.

Alternative Device Controls

Devices 16 may also be controlled in a number of other ways.

FIG. 4 illustrates devices 16 controlled using two remote control approaches for use in embodiments where devices 16 are connection/disconnection devices 16. In installations where multiple power outlets must be protected with devices 16, such as stores selling musical, audiovisual, or other consumer electronic appliances, it may be desirable to provide for remote actuation of devices 16. For example, in a music store with multiple electronic instruments connected to a power source and positioned over a large area of floor space, it may be difficult or inconvenient for store personnel, upon learning of electrical storms in the area, to rapidly move about the store to disconnect all of the instruments or ensure that all electrical circuit connection/disconnection devices 16 affixed to each of the outlets in the store are activated to protect the sensitive musical equipment. Moreover, if many such devices 16 are in use, it may be possible for store personnel to inadvertently miss one or more of the devices 16, thereby exposing expensive inventory to potential harm from severe electrical surges. In the system shown in FIG. 4, one remote activation device or transmitter 22 sends out a signal that is received by detectors 24, each of which detectors 24 are connected to electrical circuit connection/disconnection devices 16. The signal from transmitter 22 activates each of the electrical circuit connection/disconnection devices 16, ensuring that all electrical connections between the equipment to be protected and the power grid are simultaneously severed. Devices 16 may be configured to be sensitive to only certain commands from transmitter 22 so that each device 16 can respond independently or in unison with other devices, depending on the signal from transmitter 22. Transmitter 22 could use a variety of conventional technologies, including infrared signals like those used in television remote controls, radio frequency signal, laser beams, and any other control signal.

Alternatively or additionally, each of the devices 16 may be connected to a common network which may be controlled by a central control device 26 such as a computer or a dedicated control terminal. In this manner, a user may directly control all of the devices 16 in unison, and may activate or deactivate devices 16 independently. Alternatively, the devices 16 may be connected to central control device 26 over the Internet, a local area network, or computer, wireless, cellular or other network topologies.

The various features, control systems and network arrangements described above may be used in combination with each other or in combination with other detection systems such as those described in the '899 patent or as otherwise may be known or later developed.

As illustrated in FIG. 5, device 16 may also be controlled by electrical or electronic equipment 19. A communication line 27 may be provided between the electronic equipment (such as a television) 19 and the protection device 16. In this manner, when electronic equipment 19 is switched on or off, it sends a signal to protection device 16 that commands device 16 to interrupt or reconnect the circuit between plug 50 and outlet 52 as appropriate. (Battery or other auxiliary power may be necessary to accomplish this switching when the equipment 19 is not connected to another power source). This approach is advantageous, because it assures that whenever electrical equipment 19 is turned off, its connection to the power grid is completely severed. In essence, this is a manual approach to activating device 16 that is coordinated with the operation of electrical equipment 19. In the system of FIG. 5, device 16 may also be controlled by a detector circuit as described in the '899 patent, other detection circuits and/or any of the other control approaches described below.

Devices 16 may be supplemented by other devices providing additional functionality. As illustrated in FIG. 5, device 16 may be supplemented with a surge suppressor 78. Surge suppressor 78 may be any conventional surge suppression device, such as those using metal oxide varistors. Surge suppressor 78 attenuates variations in voltage supplied by plug 50, thereby preventing transient voltages from passing through outlet 52 and damaging electronic equipment 19. Surge suppressors 78 and protection devices 16 may be configured so that a suppressor 78 may be easily removed from device 16 when an indicator signals that suppressor 78 no longer exhibits surge suppressing characteristics and a new suppressor 78 may be inserted into device 16. For example, this functionality may be enabled by housing surge suppressors 78 in a plug-in module.

Circuit Interruption Device

FIGS. 6 and 7 illustrate in detail an embodiment of an electrical circuit connection/disconnection device 17 of the type contemplated in this invention and described above as device 16. Device 17 includes rotary block 28, contact rods 30, contact blocks 32 and 34, side supports 36 and 38, motor 40, receiver circuit 42, and batteries 44. Rotary block 28 is a cylinder constructed of a material which is sufficiently insulative to prevent a voltage of 6,000 volts or more from passing through block 28. Block 28 may be made of glass, nylon, plastic or any other appropriate insulative material. The diameter selected for block 28 will depend on the permittivity of the selected material. If block 28 is to be very small in diameter, a low permittivity must be used. In contrast, if block 28 is to be very large in diameter, the material used for block 28 may have a higher permittivity, although the acceptable diameter of block 28 will also be a function of the resulting length of the path (presumably through air or another gas around block 28).

Contact rods 30 are positioned within and along a diameter of block 28. Contact rods 30 extend from one side of rotary block 28 to another and are positioned generally in parallel with respect to each other. Contact rods 30 may be made of brass, aluminum, copper, or any other suitable conductive material. Contact blocks 32 and 34 are positioned adjacent to rotary block 28 such that contacts 31, positioned within contact blocks 32 and 34, correspond to the locations where contact rods 30 protrude slightly from either side of rotary block 28. In this manner, when contact blocks 32 and 34 are adjacent to rotary block 28 and contact rods 30 are aligned with contacts 31, electricity may pass from contacts 31 on block 28 through contact rods 30 to contacts 31 on block 32 and vice versa. As will be readily understood by one skilled in the art, many types of conductors through block 28 may be used, as well as a variety of brushes, springs or other suitable mechanisms acting as contacts 31 to complete the necessary circuits.

Side supports 36 and 38 have holes 46 which receive pins 48 which extend from either side of rotary block 28. Moreover, side supports 36 and 38 are affixed to contact blocks 32 and 34 thereby joining the assembly into one integrated unit as illustrated in FIG. 7. Motor 40 is affixed to pin 48 via hole 46, thereby allowing motor 40 to rotate rotary block 28 as described below. Block 28 could also be rotated through the 90° rotation necessary in other ways, such as by a solenoid acting on a lever arm attached to one of the pins 48.

Motor 40 is connected to and controlled by receiver circuit 42, both of which in turn are powered by batteries 44. Receiver circuit 42 receives control signals using one or more of the approaches described above.

Referring to FIGS. 6 and 7, to operate device 17, a control signal is received by receiver circuit 42. When the appropriate control signal is received, thereby indicating that the external conductors to electrical equipment 18 and 19 connected to outlet 52 should be interrupted, receiver circuit 42 controls motor 40 (or another rotation mechanism), which rotates rotary block 28 so that contact rods 30 are aligned perpendicularly to a line connecting contacts 31 of block 32 and contacts 31 of block 34. In this manner, the only path between contacts 31 of block 32 and contacts 31 of block 32 is interrupted by the insulative material making up rotary block 28. If and when a control signal indicating that the external conductors may be reconnected to electronic equipment 18 and 19 connected to outlet 52, receiver circuit 42 may activate motor 40 to rotate rotary block 28 into a position where contact rods 30 connect contacts 31 of block 32 and contacts 31 of block 34, thereby providing a direct conductive path between contacts 31 of blocks 32 and 34. FIG. 8 illustrates the relationship between rotary block 28, contact rod 30 and contacts 31 in a connected state. FIG. 9 illustrates this relationship in a disconnected state. Rotary block 28 may have a hand lever 56 which, when pulled, would allow for manual operation of rotary block 28.

Controlling Power and Other Circuits

As illustrated in FIG. 10, device 16 may be connected to conventional plugs 50 and conventional outlets 52 in order to access and control conventional home power supplies and allow conventional electronic devices to be plugged into device 16. In addition, additional lines 53 may be provided to protect modem, cable television, computer network or other electrical paths as may be desired and appropriate.

Gas or Vacuum Relay Disconnect/Connect Mechanism

As illustrated in FIG. 11, the systems of this invention may use a vacuum or gas-filled relay 58. The gas 60 present (or the relative absence of gas in a “vacuum”) in relay 58 are sufficiently insulative that the gap 62 between contacts 64 and 66 of relay 58 when it is open cannot be bridged by voltages of 6,000 volts or more. To operate relay 58, receiver circuit 42 receives a control signal in one of the alternative ways described above and activates a relay 58 to separate contacts 64 and 66, thereby interrupting the electrical contact between plug 50 and outlet 52.

Manual Activation

As illustrated in FIGS. 12 and 13, connection and disconnection may be achieved manually. Contact rods 33 housed within insulation block 68 are normally in contact with contacts 30. As shown in FIG. 13, depressing plunger 70 forces compression spring 72 and displacement of insulation block 68 and contact rod 33. Insulation block 68 includes a detente, which at maximum displacement is engaged and held by latch 74. Releasing latch 74 allows device 16 to be reset.

Uninterruptible Power Supply

As illustrated in FIG. 14, a device 16 may be combined with an uninterruptable power supply 80. Uninterruptable power supply 80 may be any conventional device for providing continued power to an electronic device when the power normally provided through plug 50 to outlet 52 is interrupted either by activation of lighting protection device 16 or failure of power delivery to the local electronic grid. Such power can be provided, for instance, by batteries, an auxiliary generator, and other energy storage or supply devices, including fuel cells, flywheels, any electromagnetic storage device, or any other alternative method of providing auxiliary power. The combination of uninterruptible power supply 80 and protection device 16 is advantageous because it allows use of device 16 even with electrical equipment 18 that is sensitive to unanticipated interruptions in the power supply. Upon detecting lightning storms in the area or otherwise receiving control signals, device 16 may interrupt the circuit between electrical equipment 18 and 19 and the power grid, thereby eliminating the risk of lightning induced power surges from entering the circuit and damaging the electronic equipment. At the same time, uninterruptable power supply 80 will sense the loss of power and will begin providing continued power to the electronic device thereby avoiding harm that might arise from the sudden and unanticipated deprivation of electrical power. Uninterruptable power supply 80 may operate in a conventional manner, for instance, or activation of the uninterruptable power supply 80 may also trigger software which commands the electronic device to begin a shut-down procedure, thereby assuring that the device is properly shut down rather than shut down by the power failure.

Circuit Interruption Device

FIG. 15 illustrates in detail a rotating disk embodiment 90 of an electrical circuit connection/disconnection device of the type contemplated in this invention and described above as device 16. Cam 92 includes disc portion 120 having center hole 122, a plurality of disengagement ridges 124, and a plurality of alternating dielectric tabs 126 and gaps 127. Ridges 124 are integrally attached along the perimeter of disc portion 120 and extend transverse to disc portion 120. Tabs 126 are integrally attached to ridges 124 and extend radially from disc portion 120. Cam 92 may be constructed of a material similar to rotary block 28 of device 17.

Contact blocks 94 and 96 are parallel to each other and positioned above and below cam 92. Contact block 96 has a center hole 97 and an array of external conductor contacts 98 positioned generally in a plane. Contact block 94 has corresponding equipment side contacts 100 positioned normally to contacts 98.

Cam 92 is secured between blocks 96 and 98 on shaft 118 such that tabs 126, gaps 127, and the ends of contacts 98 and 100 define circles having an equal radius with respect to holes 122 and 97. As will be appreciated by reference to FIGS. 16 and 17, rotation of cam 92 alternatively permits contacts 100 to mate with contacts 98, or break such contacts when the tabs 126 are between the pairs of contacts 98 and 100.

Interface 104 includes electrical input connections for electrical conductors such as, for example, power sources, datalines, coaxial cable, telephone lines, low voltage control lines, and any other digital or analog electrical source or signal used as an external conductor in electrical and electronic equipment. Each of the plurality of electrical connections are electrically connected to one of the external conductor contacts 98. Interface 106 includes output connections electrically connected to one of the plurality of equipment side contacts.

Referring to FIGS. 16 and 17, device 90 operates similar to device 17 described above in detail. FIG. 16 illustrates device 90 in a connected state. In the connected state, contacts 100 are positioned between adjacent tabs 126 within gaps 127 such that the elastic force enables contacts 100 and contacts 98 to be in electrical contact.

FIG. 17 illustrates device 90 in a disconnected states. When the appropriate disconnect control signal is received, receiver circuit 112 controls motor 108, which rotates shaft 118, which in turn rotates cam 92. As cam 92 is rotated, ridges 124 rotate thereby forcing contacts 100 to move away from contacts 98. At the same time, tabs 128 are interposed between contacts 98 and 100 thereby providing sufficient separation to prevent voltages of 6,000 volts or more from passing through tabs 128. When the appropriate reconnect control signal is received, receiver circuit 112 controls motor 108, which rotates cam 92. As cam 92 is rotated to the connected state shown in FIG. 16, ridges 124 and tabs are removed from between contacts 98 and 100 and the pair of contacts again mate.

Multiple Pole Single Throw Relay Disconnect/Connect Mechanism

As illustrated in FIG. 18, a disconnect, connect device 16 may also use a multiple pole single throw relay for the disconnect/connect mechanism. In the connected state, the relay provides electrical connectivity between the electrical or electronic equipment 18 and 19 and all external conductors that are electrically connected to equipment side contacts 132. Equipment side contacts 132 are connected to external contacts 134, which make electrical contact with lever member 136 when the relay is in the closed position. Lever member 136 may be pivotally attached to plunger 138, which moves in and out of solenoid 140 in response to activation of solenoid 140. When the receiver circuit receives a control signal as described above, movement of plunger 138 along the axis of solenoid 140 causes lever member 136 to separate contacts 134 from contacts 132 a distance sufficient to prevent at least 6,000 volts from bridging the gap between contacts 132 and 134.

As will be appreciated by those skilled in the art, numerous modifications can be made in this invention without departing from the spirit of the invention as described and illustrated herein and the following claims.

1. A response system, comprising:
(a) a regional transmitter for transmitting a control signal;
(b) a plurality of receivers adapted to receive the control signal; and
(c) at least one automatic response device, each device associated with one of the receivers and adapted to perform a function.

2. The response system of claim 1, wherein the control signal is an infrared signal.

3. The response system of claim 1, wherein the control signal is a radio frequency signal.

4. A monitoring and response system, comprising:
(a) a monitoring device for detecting at least one condition;
(b) a plurality of regional transmitters adapted to transmit control signals to a geographic area;
(c) a plurality of receivers within the geographic area adapted to receive the control signal; and
(d) at least one automatic response device, each automatic response device associated with one of the receivers, the automatic response device adapted to perform a function.

5. The monitoring and response system of claim 4, wherein at least two of the plurality of regional transmitters transmit control signals to different portions of the geographic area.

6. The monitoring and response system of claim 5, wherein the at least two of the plurality of regional transmitters transmit control signals to the different portions of the geographic area using the same control signal.

7. The monitoring and response system of claim 4, wherein the monitoring device is adapted to detect at least one environmental condition.

8. The monitoring and response system of claim 7, wherein the monitoring device is adapted to receive notifications from a weather monitoring and notification service.

9. The monitoring and response system of claim 4, wherein the monitoring device monitors the at least one condition by monitoring precursor conditions.

10. A method for a service provider to provide notification service to at least one location having an automatic response device, the method comprising:
(a) monitoring at least one condition; and
(b) upon detecting the condition, transmitting or ceasing transmitting at least one control signal to the automatic response device that responds to the presence or absence of the control signal by performing a function.

11. The method of claim 10, wherein monitoring the at least one condition comprises monitoring at least one environmental condition.

12. The method of claim 11, wherein monitoring the at least one environmental condition comprises monitoring precursor conditions to the at least one environmental condition.

13. The method of claim 10, wherein monitoring the at least one condition comprises monitoring notifications from a weather monitoring and notification service.

14. The method of claim 10, wherein transmitting control signals comprises transmitting the control signals to different portions of a geographic area using different regional transmitters.

15. The method of claim 14, wherein transmitting control signals comprises transmitting a common control signal to the different portions of the geographic area.

16. The method of claim 10, wherein monitoring the at least one condition comprises monitoring the absence of an environmental condition.
